(19) United States
(12) Patent Application Publication
(10) Pub. No.: US 2025/0150963 A1
(43) Pub. Date: May 8, 2025

(54) ADAPTIVE POWER PRESERVATION FOR CELL SITES

(71) Applicant: T-Mobile USA, Inc., Bellevue, WA (US)

(72) Inventor: Chaitanya Chukka, Downers Grove, IL (US)

(21) Appl. No.: 18/504,146

(22) Filed: Nov. 7, 2023

(51) Int. Cl. H04W 52/02; H04L 43/065; H04W 24/08

(52) U.S. Cl. CPC H04W 52/0206; H04L 43/065; H04W 24/08

(57) ABSTRACT

Solutions are disclosed that provide adaptive power preservation for cell sites. Examples collect predicted environmental condition information for a base station and historical power consumption data for a plurality of electrically-powered assets located at the base station. A power usage profile is predicted for the base station using the historical power consumption data and the environmental condition information, and performance of secondary power sources at the base station are predicted (e.g., solar and wind power generation performance using weather predictions). Using the predictions, a power preservation action is selected, such as diverting incoming primary power to recharge a battery, using battery charge in lieu of primary power for at least one of the electrically-powered assets located at the base station (e.g., the tower light or cooling equipment), and selectively powering one of the electrically-powered assets (e.g., 5G radio) while reducing power to another (e.g., 4G radio).

### BACKGROUND

Mitigating climate change requires intelligent management of technologies that consume power, such as cellular (cell) base station sites. With fifth generation (5G) and other wireless networks (e.g., cellular networks) employing advanced bandwidth-enhancing solutions, such as carrier aggregation, and the increasing density of cell sites, the amount of consumed power may be generally increasing.

Unfortunately, during power outages, such as weather-related disruptions of electric utility power distribution (e.g., downed power lines), a cell site is not only starved of its primary power source, but first responders and other emergency work crews may need cellular connectivity to coordinate search and rescue and other recovery operations. Thus, it is paramount to enable a cell site to operate reliably during power outages without undue reliance on combustion-powered on-site generators. This requires an approach to power preservation (e.g., efficient power usage and management) that intelligently adapts to the cell site's environment.

### SUMMARY

The following summary is provided to illustrate examples disclosed herein, but is not meant to limit all examples to any particular configuration or sequence of operations.

Solutions are disclosed that provide adaptive power preservation for cell sites. Examples collect predicted environmental condition information for a base station of a wireless network; collect historical power consumption data for a plurality of electrically-powered assets located at the base station; using the historical power consumption data and the environmental condition information, predict, at the base station, a power usage profile for the base station, wherein the power usage profile includes power consumed by the plurality of electrically-powered assets; predict, at the base station, performance of a secondary power source at the base station; and using the predicted power usage profile and the predicted performance of the secondary power source, select, at the base station, a power preservation action from the list consisting of: diverting incoming primary power to recharge a battery, using battery charge in lieu of primary power for at least one of the electrically-powered assets located at the base station, and selectively powering one of the electrically-powered assets while reducing power to another.

### BRIEF DESCRIPTION OF THE DRAWINGS

The disclosed examples are described below with reference to the accompanying drawing figures listed below, wherein:

FIG. 1 illustrates an exemplary architecture that advantageously provides adaptive power preservation for cell sites;

FIG. 2 illustrates a cell site of the example architecture of FIG. 1;

FIG. 3 illustrates further detail for the example tower of the example cell site of FIG. 2;

FIG. 4 illustrates example equipment that may be located at the example cell site of FIG. 2;

FIG. 5 illustrates exemplary electrically-powered assets that may be located at the example cell site of FIG. 2;

FIG. 6 illustrates exemplary secondary power sources that may be located at the example cell site of FIG. 2;

FIG. 7 illustrates exemplary power preservation logic of the example architecture of FIG. 1;

FIGS. 8 and 9 illustrate flowcharts of exemplary operations associated with the architecture of FIG. 1; and

FIG. 10 illustrates a block diagram of a computing device suitable for implementing various aspects of the disclosure.

Corresponding reference characters indicate corresponding parts throughout the drawings. References made throughout this disclosure. relating to specific examples, are provided for illustrative purposes, and are not meant to limit all implementations or to be interpreted as excluding the existence of additional implementations that also incorporate the recited features.

### DETAILED DESCRIPTION

Solutions are disclosed that provide adaptive power preservation for cell sites. Examples collect predicted environmental condition information for a base station and historical power consumption data for a plurality of electrically-powered assets located at the base station. A power usage profile is predicted for the base station using the historical power consumption data and the environmental condition information, and performance of secondary power sources at the base station are predicted (e.g., solar and wind power generation performance using weather predictions). Using the predictions, a power preservation action is selected, such as diverting incoming primary power to recharge a battery, using battery charge in lieu of primary power for at least one of the electrically-powered assets located at the base station (e.g., the tower light or cooling equipment), and selectively powering one of the electrically-powered assets while reducing power to another.

Aspects of the disclosure improve the efficiency of cellular networks by intelligently adapting power preservation measures to predicted environmental conditions at a base station. The result is that, with improved efficiency, reliance on combustion-powered on-site generators for back-up power is reduced. This advantageous result is accomplished, at least in part, by using historical power consumption data and environmental condition information, predicting, at a base station, a power usage profile for the base station.

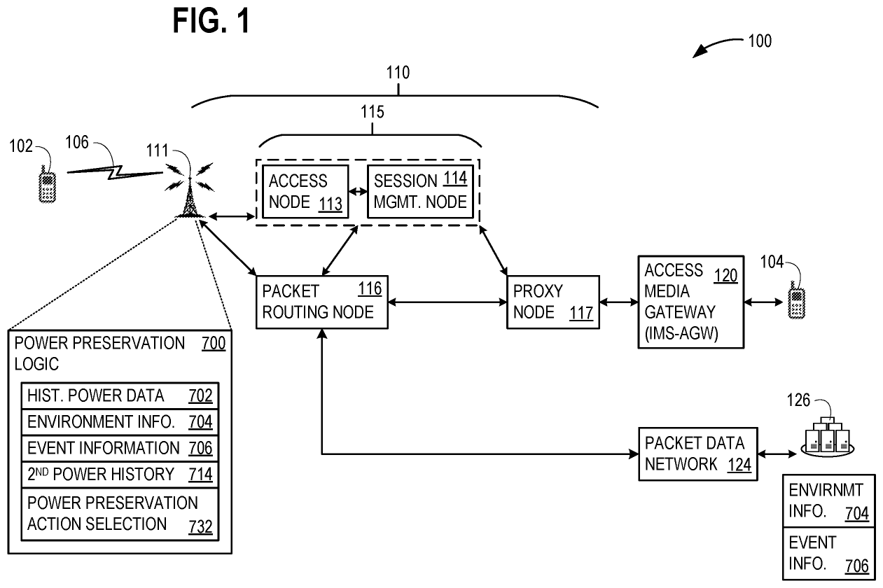

With reference now to the figures, FIG. 1 illustrates an exemplary architecture 100 that advantageously provides intelligent adaptive power preservation. A user equipment (UE) 102 uses a wireless network 110 for a call with another UE 104 or for a packet data session to reach a network resource 126 (e.g., a website) across an external packet data network 124 (e.g., the internet). Wireless network 110 may be a cellular network such as a fifth generation (5G) network, a fourth generation (4G) network, or another cellular generation network.

UE 102 uses an air interface 106 to communicate with a base station 111 of wireless network 110. In some scenarios, base station 111 may be referred to as a radio access network (RAN). Wireless network 110 has a core network 115 comprising an access node 113, a session management node 114, and other components (not shown). Wireless network 110 also has a packet routing node 116 and a proxy node 117. Access node 113 and session management node 114 are within a control plane of wireless network 110, and packet routing node 116 is within a user plane of wireless network 110.

Base station 111 is in communication with access node 113 and packet routing node 116. Access node 113 is in communication with session management node 114. Packet routing node 116 is in communication with session management node 114, proxy node 117, and packet data network 124. In some 5G examples, base station 111 comprises a gNodeB (gNB), access node 113 comprises an access mobility function (AMF), session management node 114 comprises a session management function (SMF), and packet routing node 116 comprises a user plane function (UPF).

In some 4G examples, base station 111 comprises an eNodeB (eNB), access node 113 comprises a mobility management entity (MME), session management node 114 comprises a system architecture evolution gateway (SAEGW) control plane (SAEGW-C), and packet routing node 116 comprises an SAEGW-user plane (SAEGW-U). In some examples, proxy node 117 comprises a proxy call session control function (P-CSCF) in both 4G and 5G.

In some examples, wireless network 110 has multiple ones of each of the components illustrated, in addition to other components and other connectivity among the illustrated components. In some examples, wireless network 110 has components of multiple cellular technologies operating in parallel in order to provide service to UEs of different cellular generations. As used herein a base station is a generic term for the radio equipment located at a cell site. For example, base station 111 may comprise both a gNB and eNB, providing a mix of 5G and 4G cells co-located at a common cell site.

Proxy node 117 is in communication with an internet protocol (IP) multimedia system (IMS) access gateway (IMS-AGW) 120 within an IMS, in order to provide connectivity to other wireless (cellular) networks, such as for a call with UE 104 or a public switched telephone system (PSTN, also known as plain old telephone system, POTS). In some examples, proxy node 117 may be considered to be within the IMS. UE 102 reaches network resource 126 using packet data network 124 or IMS-AGW 120, in some examples. Data packets from UE 102 pass through at least base station 111 and packet routing node 116 on their way to packet data network 124 or IMS-AGW 120 (via proxy node 117).

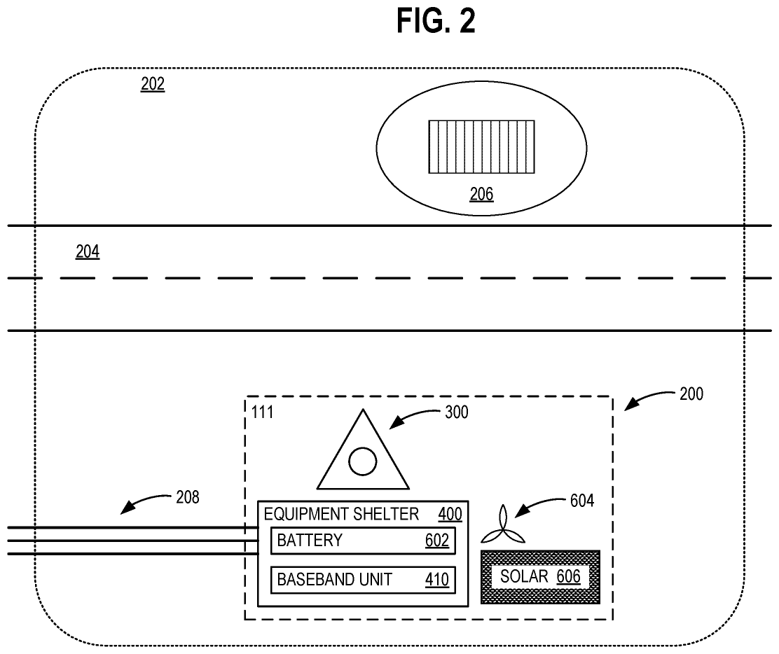

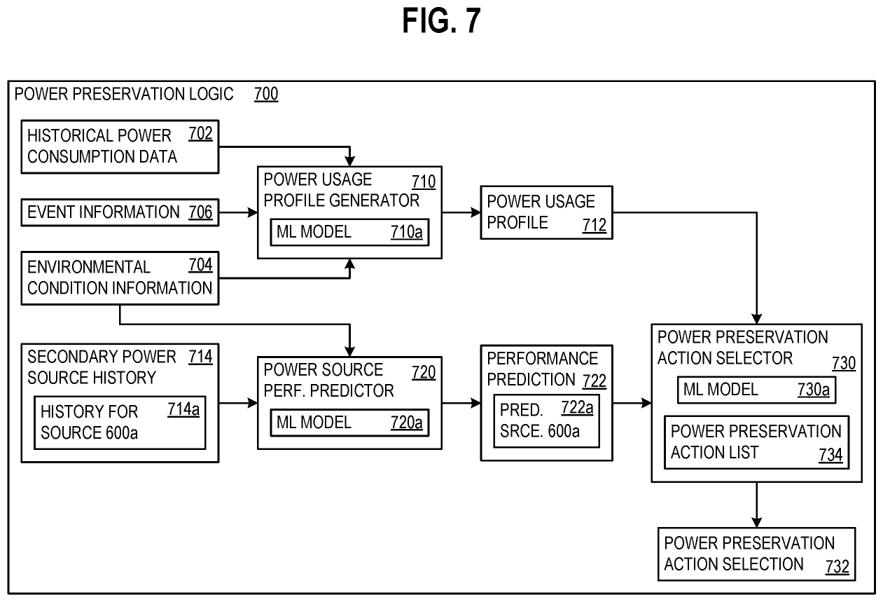

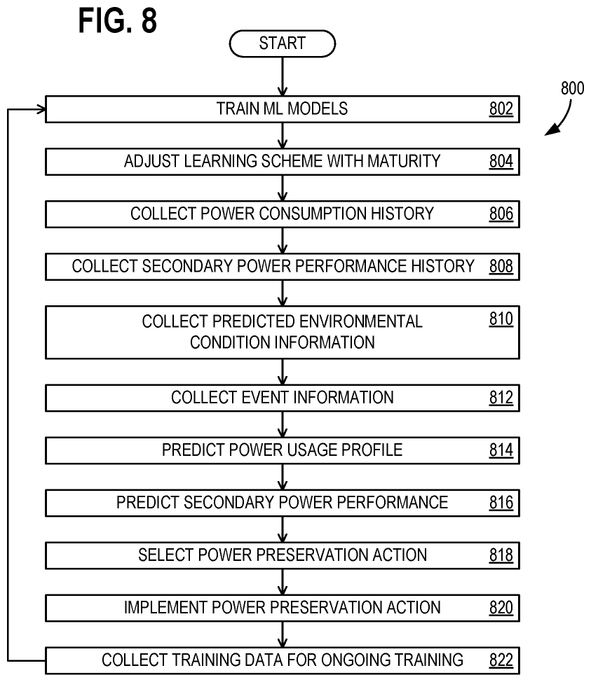

Base station 111 has power preservation logic 700 that provides adaptive power preservation for a cell site 200 (shown in FIG. 2), as described in further detail in relation to the following figures. Power preservation logic 700 has historical power consumption data 702, environmental condition information 704, event information 706 regarding an upcoming event, historical data 714 regarding performance of a plurality of secondary power sources 600 (shown in FIG. 6), and a selection 732 of a power preservation action used to conserve power at base station 111. Power preservation logic 700 is described in further detail below, for example in relation to FIG. 7.

Environmental condition information 704 may comprise a forecast temperature and/or a weather event (e.g., a forecast storm) associated with an increased likelihood of a power outage for base station 111 and/or a reduction in performance of battery power. Event information 706 is information for an event associated with an increased number of wireless network in the vicinity of base station 111, such as a predicted traffic condition (e.g., rush hour traffic on a road within the coverage area of base station 111) and/or an event at a facility in the vicinity of base station 111 (e.g., a concert or sporting event). In some examples, environmental condition information 704 and event information 706 are retrieved by power preservation logic 700 from network resource 126 (e.g., one or more websites).

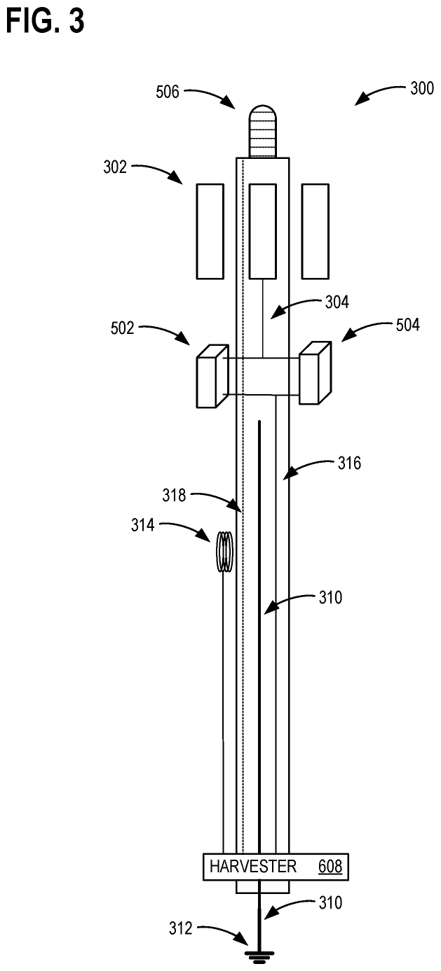

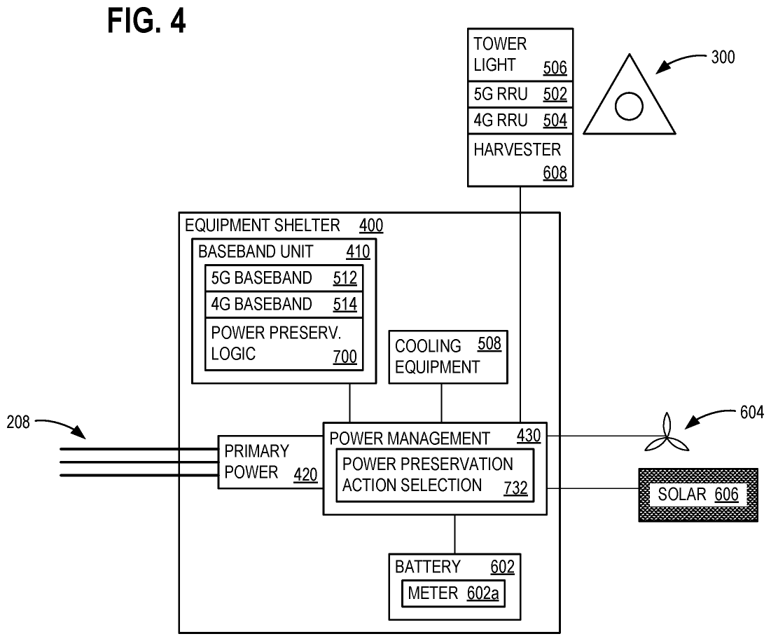

FIG. 2 illustrates cell site 200 where base station 111 is located. Base station 111 has a tower 300, which is shown in further detail in FIG. 3, and an equipment shelter 400. Equipment shelter 400 houses a battery 602 and a baseband unit 410, and is illustrated in further detail in FIG. 4. Base station 111 also has a wind-powered generator 604 and a solar-powered generator 606 to provide secondary (supplemental power) in an effort to mitigate climate change. As used herein, the term base station is generic and includes not only radio equipment for a single cell, but also radio equipment for co-located cells (including different cellular generation cells), the cell tower, and other equipment and components.

As illustrated base station 111 is supplied with utility power lines 208 that run to cell site 200. A road 204, which may have periods of high traffic (e.g., predicted in event information 706) and a facility 206 are within vicinity 202 of base station 111. Facility 206 may be a sports stadium, a concert venue, fairgrounds, or some other facility that hosts large groups of cellular users. In some examples, event information 706 provides calendar scheduling information for an event at facility 206.

FIG. 3 illustrates further detail for tower 300 of base station 111. Tower 300 has a tower light 506, a 5G remote radio unit (RRU) 502, a 4G RRU 504, antennas 302, radio frequency (RF) cabling 304 running from RRUs 502 and 504 to antennas 302, power cabling 316 to RRUs 502 and 504, and power cabling 318 to tower light 506. For clarity of FIG. 3, fiber optic cabling running up tower 300 to RRUs 502 and 504 is not shown. Tower light 506 is a safety feature used for aircraft warning.

Ground straps 310 run between various equipment and points on tower 300 to a safety ground 312, to reduce electrical hazards. In some examples, a power harvester 608 is attached to ground straps 310 to harvest stray power dissipation that would otherwise be wasted as heat. Power harvester 608 may comprise a capacitor, a rectifier, and a charge pump, and outputs power that may be used toward recharging battery 602. In some examples, power harvester 608 also recovers stray electrical currents from exterior sheathing of RF cabling 304 and power cabling 316 and 318. In some examples, an induced current conductor 314 converts atmospheric electrical energy (e.g., nearby lightning) into electrical currents for recovery by power harvester 608. Although power harvester 608 is illustrated as a single component, it may instead be a distributed arrangement with separate taps for each of the different cables and straps.

FIG. 4 illustrates example equipment within equipment shelter 400. Equipment shelter 400 houses a baseband unit 410, a power management unit 430, and cooling equipment 508 (including heating, air circulation, and dehumidification, as needed) that maintains the proper temperature within equipment shelter 400 for baseband unit 410, power management unit 430, and battery 602. Baseband unit 410 has 5G baseband equipment 512, 4G baseband equipment 514, and power preservation logic 700.

Power management unit 430 manages the intake, storage, and distribution of electrical power for base station 111. Power management unit 430 receives electrical power from incoming primary power 420 over utility power lines 208, as well as power from wind-powered generator 604, solar-powered generator 606, and power harvester 608. Power management unit 430 selectively stores power in or retrieves power from battery 602, and monitors a battery charge meter 602a that measures the power level of battery 602. When battery 602 stores power for an extended period of time parasitic power losses (including internal losses) may drain power from battery 602. Battery charge meter 602a is able to track this, and power preservation logic 700 may opt to use charge from battery 602 or resell electrical power back to the utility company over utility power lines 208, rather than let the power be wasted.

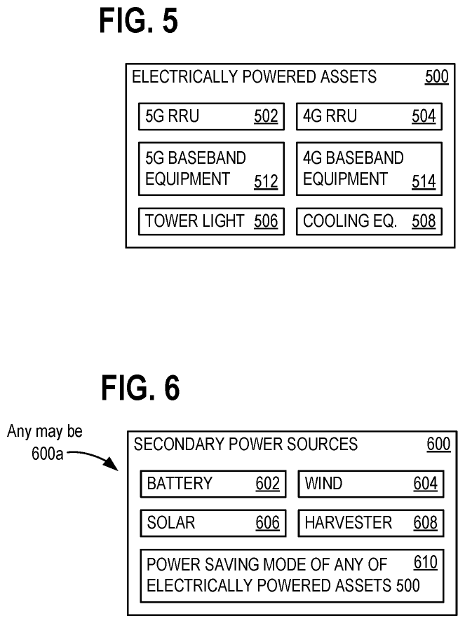

Power management unit 430 provides power to electrically-powered assets 500 (shown in FIG. 5), such as tower light 506, 5G RRU 502, and 4G RRU 504 on tower 300; and baseband unit 410 and cooling equipment 508 within equipment shelter 400. Power management unit 430 implements selection 732 provided by power preservation logic 700 (as described below in relation to FIG. 7).

FIG. 5 illustrates a plurality of exemplary electrically-powered assets 500 that may be located at base station 111. Electrically-powered assets 500 includes 5G RRU 502, 4G RRU 504, tower light 506, cooling equipment 508, and 5G baseband equipment 512, and 4G baseband equipment 514 within baseband unit 410.

FIG. 6 illustrates a plurality of exemplary secondary power sources 600 that may be located at base station 111. Secondary power sources 600 includes battery 602, wind-powered generator 604, solar-powered generator 606, and power harvester 608. In some examples, a power saving mode 610 for one or more of electrically-powered assets 500 is also considered to be a secondary power source. Any one of secondary power sources 600 may be a secondary power source 600a. In the description of FIG. 7, power preservation logic 700 is described as using historical information for at least one secondary power source, and the generic representation of secondary power source 600a (as any one of secondary power sources 600) is used for this purpose.

FIG. 7 illustrates further detail for power preservation logic 700. Power preservation logic 700 resides within base station 111, such as within baseband unit 410 (in some examples). Power preservation logic 700 is illustrated as including a power usage profile generator 710, a secondary power performance predictor 720, and a power preservation action selector 730.

Historical power consumption data 702 for electrically-powered assets 500 and environmental condition information 704 are used by power usage profile generator 710 to generate a predicted power usage profile 712 for electrically-powered assets 500 during some time period in the future (e.g., a time of day, a day of week, and/or a specific date). For example, high temperatures may place a high demand on cooling equipment 508. In some examples, power usage profile generator 710 also uses event information 706. For example, an expected influx of UEs into vicinity 202 is likely to place a higher remand on 5G RRU 502, 4G RRU 504, 5G baseband equipment 512, and 4G baseband equipment 514. In some examples, power usage profile generator 710 comprises a machine learning (ML) model 710a. As used herein, ML includes artificial intelligence (AI).

Historical data 714 regarding performance of the plurality of secondary power sources 600 (including historical data 714a regarding performance of secondary power source 600a) us used by secondary power performance predictor 720 to predict performance 722 of the plurality of secondary power sources (including performance 722a of secondary power source 600a) during some time period in the future (e.g., a time of day, a day of week, and/or a specific date). The time periods of performance 722 and power usage profile 712 may overlap or be effectively coincident.

In some examples, secondary power performance predictor 720 also uses environmental condition information 704 to predict performance 722. For example, low temperatures may negatively impact the performance of battery 602, windy (or calm) conditions may impact the performance of wind-powered generator 604, and rain, cloudy or sunshine conditions may impact the performance of solar-powered generator 606.

When battery 602 stores power for an extended period of time parasitic power losses (including internal losses). In some examples, power preservation logic 700 monitors battery charge meter 602a to identify parasitic losses of battery 602 and includes this in historical data 714. In some examples, secondary power performance predictor 720 comprises an ML model 720a.

Power usage profile 712 and performance 722 (or performance 722a) are used by power preservation action selector 730 to select a power preservation action from a power preservation action list 734 as selection 732. In general, selection 732 is valid for the time period in which performance 722 and power usage profile 712 overlap (e.g., a time of day, a day of week, and/or a specific date in the future). In some examples, power preservation action selector 730 comprises an ML model 730a. In some examples, power preservation action list 734 includes diverting at least some of incoming primary power 420 to recharge battery 602, using battery charge from battery 602 in lieu of primary power 420 for at least one of electrically-powered assets 500, and selectively powering one of electrically-powered assets 500 while reducing power to another one of electrically-powered assets 500.

For example, if there is insufficient power to operate both 5G and 4G cells, one may be selected to continue operating, while the other is put into power saving mode. Operating 5G requires powering 5G RRU 502 and 5G baseband equipment 512. 4G RRU 504 and 4G baseband equipment 514 may then be put into power saving mode. Using battery charge in lieu of primary power 420 for at least one of electrically-powered assets 500 may include powering tower light 506 and/or cooling equipment 508 with battery 602. Other options include powering tower light 506 and/or cooling equipment 508 with wind-powered generator 604 and/or solar-powered generator 606.

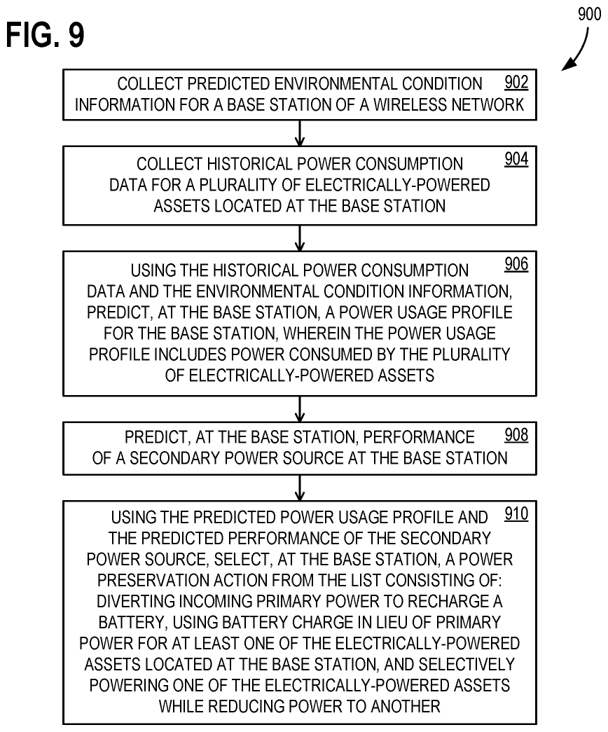

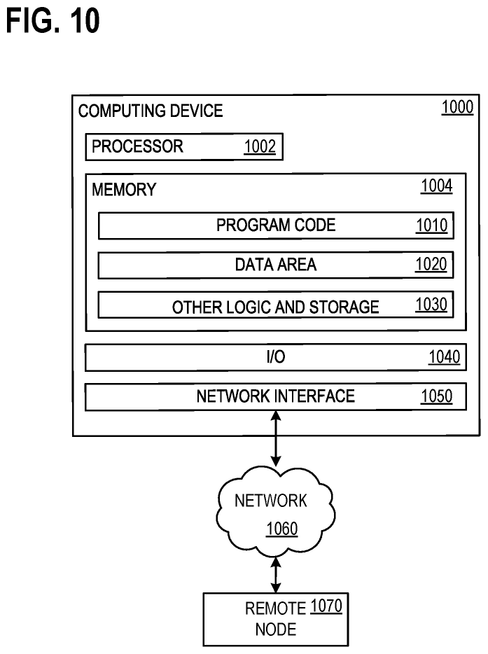

FIG. 8 illustrates a flowchart 800 of exemplary operations associated with examples of architecture 100. In some examples, at least a portion of flowchart 800 may be performed using one or more computing devices 1000 of FIG. 10. Flowchart 800 commences with training ML models 710a, 720a, and 730a at base station 111 in operation 802. Operation 804 changes the learning schemes of ML models 710a, 720a, 730a based on their maturity, such as changing the learning scheme supervised learning to unsupervised learning. In some examples, this may occur in phases, as flowchart 800 repeatedly returns to operation 804, such as first changing the learning scheme from supervised learning to reinforced learning, and then later changing the learning scheme from reinforced learning to unsupervised learning.

Operation 806 collects historical power consumption data 702 for plurality of electrically-powered assets 500, and operation 808 collects at least historical data 714a regarding performance of secondary power source 600a (and also historical data 714 regarding performance of secondary power sources 600 when more than one secondary power source is used). Secondary power sources 600 includes at least one of: power harvester 608, wind-powered generator 604, solar-powered generator 606, and a power saving mode 610 of at least one of plurality of electrically-powered assets 500.

Operation 810 collects predicted environmental condition information 704, which may include a forecast temperature and/or information on a weather event associated with an increased likelihood of a power outage for base station 111. Operation 812 collects event information 706 regarding an event associated with an increased number of wireless network users in vicinity 202 of base station 111 (e.g., a traffic condition and/or an event at facility 206).

Using historical power consumption data 702 and environmental condition information 704, power preservation logic 700 at base station 111 predicts (generates) power usage profile 712 for base station 111, in operation 814. In some examples, power preservation logic 700 also uses event information 706 to predict power usage profile 712. Power usage profile 712 predicts power consumed by plurality of electrically-powered assets 500. Using historical data 714a (and/or historical data 714), power preservation logic 700 predicts performance 722 of secondary power source 600a (and/or secondary power sources 600) at base station 111, in operation 816. In some examples, predicting performance 722 of secondary power source 600a uses environmental condition information 704. Performance 722 includes a performance prediction for at least one of: wind-powered generator 604, solar-powered generator 606, and battery 602 (e.g., temperature-dependent battery performance and/or parasitic battery drain).

Using power usage profile 712 and performance 722, power preservation logic 700 selects a power preservation action as selection 732, in operation 818. Options for selection 732, as reflected in power preservation action list 734, may include: diverting at least some of incoming primary power 420 to recharge battery 602, using battery charge from battery 602 in lieu of primary power 420 for at least one of electrically-powered assets 500, and selectively powering one of electrically-powered assets 500 while reducing power to another one of electrically-powered assets 500. In some scenarios, power usage profile 712, performance 722a (and/or performance 722), and selection 732 is each specific to a time of day, a day of week, and/or a specific date.

In operation 820, power management unit 430 implements selection 732 (the selected power preservation action). Operation 822 collects training data for ongoing training, such as by monitoring the success or failure of selection 732 in maintaining a power reserve within a target range. Flowchart 800 then returns to operation 802.

FIG. 9 illustrates a flowchart 900 of exemplary operations associated with examples of architecture 100. In some examples, at least a portion of flowchart 900 may be performed using one or more computing devices 1000 of FIG. 10. Flowchart 900 commences with operation 902, which includes collecting predicted environmental condition information for a base station of a wireless network. Operation 904 includes collecting historical power consumption data for a plurality of electrically-powered assets located at the base station.

Operation 906 includes using the historical power consumption data and the environmental condition information, predicting, at the base station, a power usage profile for the base station, wherein the power usage profile includes power consumed by the plurality of electrically-powered assets. Operation 908 includes predicting, at the base station, performance of a secondary power source at the base station. Operation 910 includes using the predicted power usage profile and the predicted performance of the secondary power source, selecting, at the base station, a power preservation action from the list consisting of: diverting incoming primary power to recharge a battery, using battery charge in lieu of primary power for at least one of the electrically-powered assets located at the base station, and selectively powering one of the electrically-powered assets while reducing power to another.

FIG. 10 illustrates a block diagram of computing device 1000 that may be used as any component described herein that may require computational or storage capacity. Computing device 1000 has at least a processor 1002 and a memory 1004 that holds program code 1010, data area 1020, and other logic and storage 1030. Memory 1004 is any device allowing information, such as computer executable instructions and/or other data, to be stored and retrieved. For example, memory 1004 may include one or more random access memory (RAM) modules, flash memory modules, hard disks, solid-state disks, persistent memory devices, and/or optical disks. Program code 1010 comprises computer executable instructions and computer executable components including instructions used to perform operations described herein. Data area 1020 holds data used to perform operations described herein. Memory 1004 also includes other logic and storage 1030 that performs or facilitates other functions disclosed herein or otherwise required of computing device 1000. An input/output (I/O) component 1040 facilitates receiving input from users and other devices and generating displays for users and outputs for other devices. A network interface 1050 permits communication over external network 1060 with a remote node 1070, which may represent another implementation of computing device 1000. For example, a remote node 1070 may represent another of the above-noted nodes within architecture 100.

### Additional Examples

An example system comprises: a processor; and a computer-readable medium storing instructions that are operative upon execution by the processor to: collect predicted environmental condition information for a base station of a wireless network; collect historical power consumption data for a plurality of electrically-powered assets located at the base station; using the historical power consumption data and the environmental condition information, predict, at the base station, a power usage profile for the base station, wherein the power usage profile includes power consumed by the plurality of electrically-powered assets; predict, at the base station, performance of a secondary power source at the base station; and using the predicted power usage profile and the predicted performance of the secondary power source, select, at the base station, a power preservation action from the list consisting of: diverting incoming primary power to recharge a battery, using battery charge in lieu of primary power for at least one of the electrically-powered assets located at the base station, and selectively powering one of the electrically-powered assets while reducing power to another.

An example method of wireless communication comprises: collecting predicted environmental condition information for a base station of a wireless network; collecting historical power consumption data for a plurality of electrically-powered assets located at the base station; using the historical power consumption data and the environmental condition information, predicting, at the base station, a power usage profile for the base station, wherein the power usage profile includes power consumed by the plurality of electrically-powered assets; predicting, at the base station, performance of a secondary power source at the base station; and using the predicted power usage profile and the predicted performance of the secondary power source, selecting, at the base station, a power preservation action from the list consisting of: diverting incoming primary power to recharge a battery, using battery charge in lieu of primary power for at least one of the electrically-powered assets located at the base station, and selectively powering one of the electrically-powered assets while reducing power to another.

One or more example computer storage devices has computer-executable instructions stored thereon, which, upon execution by a computer, cause the computer to perform operations comprising: collecting predicted environmental condition information for a base station of a wireless network; collecting historical power consumption data for a plurality of electrically-powered assets located at the base station; using the historical power consumption data and the environmental condition information, predicting, at the base station, a power usage profile for the base station, wherein the power usage profile includes power consumed by the plurality of electrically-powered assets; predicting, at the base station, performance of a secondary power source at the base station; and using the predicted power usage profile and the predicted performance of the secondary power source, selecting, at the base station, a power preservation action from the list consisting of: diverting incoming primary power to recharge a battery, using battery charge in lieu of primary power for at least one of the electrically-powered assets located at the base station, and selectively powering one of the electrically-powered assets while reducing power to another.

Alternatively, or in addition to the other examples described herein, examples include any combination of the following:
the secondary power sources comprise at least one power source selected from the list consisting of: a power harvester, a wind-powered generator, solar-powered generator, and a power saving mode of an electrically-powered asset located at the base station;
predicting the performance of the secondary power source comprises using the predicted environmental condition information;
predicting the performance of the secondary power source comprises predicting at least one performance selected from the list consisting of: wind-powered generator performance, solar-powered generator performance, and battery performance;
the plurality of electrically-powered assets comprises two different generation cellular technology radios, a tower light, and cooling equipment;
the prediction of the power usage profile, the prediction of the performance of the secondary power source, and the selection of the power preservation action are performed using ML;
the predicted power usage profile, the predicted performance of the secondary power source, and the selected power preservation action is each specific to a time of day, a day of week, and/or a specific date;
collecting information regarding an event associated with an increased number of wireless network users in a vicinity of the base station;
predicting the power usage profile for the base station comprises using the collected information regarding the event;
the environmental condition information comprise temperature and/or a weather event associated with an increased likelihood of a power outage for the base station;
the event associated with an increased number of wireless network users comprises a traffic condition and/or an event at a facility in the vicinity of the base station;
the wireless network comprises a cellular network;
the two different generation cellular technologies include fifth generation (5G);
collecting historical data regarding performance of the secondary power source at the base station;
the prediction of the power usage profile, the prediction of the performance of the secondary power source, and the selection of the power preservation action are performed within a baseband unit of the base station;
predicting the performance of the secondary power source comprises predicting at least one performance selected from the list consisting of: wind-powered generator performance, solar-powered generator performance, and battery performance;
predicting battery performance comprises predicting temperature-dependent battery performance and/or parasitic battery drain;
selectively powering one of the electrically-powered assets while reducing power to another comprises selecting a radio for one generation cellular technology over a radio for a different generation cellular technology;
changing a learning scheme of the ML at the base station from supervised learning to unsupervised learning;
changing the learning scheme of the ML at the base station from supervised learning to reinforced learning; and changing the learning scheme of the ML at the base station from reinforced learning to unsupervised learning.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method of wireless communication, the method comprising:
collecting predicted environmental condition information for a base station of a wireless network;
collecting historical power consumption data for a plurality of electrically-powered assets located at the base station;
using the historical power consumption data and the environmental condition information, predicting, at the base station, a power usage profile for the base station, wherein the predicted power usage profile includes power consumed by the plurality of electrically-powered assets;
predicting, at the base station, performance of a secondary power source at the base station; and
using the predicted power usage profile and the predicted performance of the secondary power source, selecting, at the base station, a power preservation action from the list consisting of:
diverting incoming primary power to recharge a battery, using battery charge in lieu of primary power for at least one of the electrically-powered assets located at the base station, and selectively powering one of the electrically-powered assets while reducing power to another.

2. The method of claim 1, wherein the secondary power source comprise at least one power source selected from the list consisting of:
a power harvester, a wind-powered generator, solar-powered generator, and a power saving mode of an electrically-powered asset located at the base station.

3. The method of claim 1,
wherein predicting the performance of the secondary power source comprises using the predicted environmental condition information; and
wherein predicting the performance of the secondary power source comprises predicting at least one performance selected from the list consisting of:
wind-powered generator performance, solar-powered generator performance, and battery performance.

4. The method of claim 1, wherein the plurality of electrically-powered assets comprises two different generation cellular technology radios, a tower light, and cooling equipment.

5. The method of claim 1, wherein the prediction of the power usage profile, the prediction of the performance of the secondary power source, and the selection of the power preservation action are performed using machine learning (ML).

6. The method of claim 1, wherein the predicted power usage profile, the predicted performance of the secondary power source, and the selected power preservation action is each specific to a time of day, a day of week, and/or a specific date.

7. The method of claim 1, further comprising:
collecting information regarding an event associated with an increased number of wireless network users in a vicinity of the base station, wherein predicting the power usage profile for the base station comprises using the collected information regarding the event.

8. A system comprising:
a processor; and
a computer-readable medium storing instructions that are operative upon execution by the processor to:
collect predicted environmental condition information for a base station of a wireless network;
collect historical power consumption data for a plurality of electrically-powered assets located at the base station;
using the historical power consumption data and the predicted environmental condition information, predict, at the base station, a power usage profile for the base station, wherein the predicted power usage profile includes power consumed by the plurality of electrically-powered assets;
predict, at the base station, performance of a secondary power source at the base station; and
using the predicted power usage profile and the predicted performance of the secondary power source, select, at the base station, a power preservation action from the list consisting of:
diverting incoming primary power to recharge a battery, using battery charge in lieu of primary power for at least one of the plurality of electrically-powered assets located at the base station, and selectively powering one of the plurality of electrically-powered assets while reducing power to another.

9. The system of claim 8, wherein the secondary power source comprise at least one power source selected from the list consisting of:
a power harvester, a wind-powered generator, solar-powered generator, and a power saving mode of an electrically-powered asset located at the base station.

10. The system of claim 8,
wherein predicting the performance of the secondary power source comprises using the predicted environmental condition information; and
wherein predicting the performance of the secondary power source comprises predicting at least one performance selected from the list consisting of:
wind-powered generator performance, solar-powered generator performance, and battery performance.

11. The system of claim 8, wherein the plurality of electrically-powered assets comprises two different generation cellular technology radios, a tower light, and cooling equipment.

12. The system of claim 8, wherein the prediction of the power usage profile, the prediction of the performance of the secondary power source, and the selection of the power preservation action are performed using machine learning (ML).

13. The system of claim 8, wherein the predicted power usage profile, the predicted performance of the secondary power source, and the selected power preservation action is each specific to a time of day, a day of week, and/or a specific date.

14. The system of claim 8, wherein the instructions are further operative to:
collect information regarding an event associated with an increased number of wireless network users in a vicinity of the base station, wherein predicting the power usage profile for the base station comprises using the collected information regarding the event.

15. One or more computer storage devices having computer-executable instructions stored thereon, which, upon execution by a computer, cause the computer to perform operations comprising:
collecting predicted environmental condition information for a base station of a wireless network;
collecting historical power consumption data for a plurality of electrically-powered assets located at the base station;
using the historical power consumption data and the predicted environmental condition information, predicting, at the base station, a power usage profile for the base station, wherein the predicted power usage profile includes power consumed by the plurality of electrically-powered assets;
predicting, at the base station, performance of a secondary power source at the base station; and
using the predicted power usage profile and the predicted performance of the secondary power source, selecting, at the base station, a power preservation action from the list consisting of:
diverting incoming primary power to recharge a battery, using battery charge in lieu of primary power for at least one of the plurality of electrically-powered assets located at the base station, and selectively powering one of the plurality of electrically-powered assets while reducing power to another.

16. The one or more computer storage devices of claim 15, wherein the secondary power sources comprise at least one power source selected from the list consisting of:
a power harvester, a wind-powered generator, solar-powered generator, and a power saving mode of an electrically-powered asset located at the base station.

17. The one or more computer storage devices of claim 15,
wherein predicting the performance of the secondary power source comprises using the predicted environmental condition information; and
wherein predicting the performance of the secondary power source comprises predicting at least one performance selected from the list consisting of:
wind-powered generator performance, solar-powered generator performance, and battery performance.

18. The one or more computer storage devices of claim 15, wherein the plurality of electrically-powered assets comprises two different generation cellular technology radios, a tower light, and cooling equipment.

19. The one or more computer storage devices of claim 15, wherein the prediction of the power usage profile, the prediction of the performance of the secondary power source, and the selection of the power preservation action are performed using machine learning (ML).

20. The one or more computer storage devices of claim 15, wherein the predicted power usage profile, the predicted performance of the secondary power source, and the selected power preservation action is each specific to a time of day, a day of week, and/or a specific date.
